(19) United States
(12) Patent Application Publication
(10) Pub. No.: US 2024/0381894 A1
(43) Pub. Date: Nov. 21, 2024

(54) OILY FOOD CONTAINING HEAT-GENERATING MATERIAL

(71) Applicant: FUJI OIL HOLDINGS INC., Osaka (JP)

(72) Inventor: Shigeki MIZUSHIMA, Ibaraki (JP)

(21) Appl. No.: 18/689,913

(22) PCT Filed: Aug. 24, 2022
(86) PCT No.: PCT/JP2022/031817

§ 371 Date: Mar. 7, 2024

(30) Foreign Application Priority Data
Sep. 29, 2021 (JP) 2021-158566

(51) Int. Cl. A23G 1/32

(52) U.S. Cl. CPC A23G 1/325

(57) ABSTRACT

In an oily food such as chocolate or sandwich filling, by blending and dispersing in the oily food a material that generates heat by contact with moisture, such as zeolite, a calcium compound, or a mixture of a calcium compound and an organic acid, in a state not in contact with moisture so that a calorific value derived from a heat-generating material is 1.0 J/g or more per oily food, it is possible to improve melt-in-the-mouth texture of the oily food without changing triglyceride composition of oils and/or fats contained in the oily food.

### TECHNICAL FIELD

The present invention relates to an oily food.

### BACKGROUND ART

The oily food such as chocolate is a food in which oils and/or fats form a continuous phase. Therefore, texture such as melt-in-the-mouth texture of the oily food is mainly controlled by melting properties of the oils and/or fats.

Conventionally, in order to improve the melt-in-the-mouth texture of the oily food, a method for increasing purity of a specific triglyceride contained in the oils and/or fats has been proposed as an attempt to make the melting properties sharper. (PATENT LITERATURE 1) Although an effect of improving the melt-in-the-mouth texture can be obtained by this, conversely, there has been a problem that a risk such as occurrence of blooming may increase. In addition, increasing the purity of a specific triglyceride of the oils and/or fats has often been a factor of increasing production cost of the oils and/or fats.

Conventionally, in order to improve heat resistance of oily food such as chocolate, it is common practice to partially replace cocoa butter with the oils and/or fats having a relatively high melting point and containing a large amount of SOS (1,3-distearoyl-2-oleoyl triglyceride), such as sal fat, shea butter, and interesterified oils and/or fats. (PATENT LITERATURE 2) While this improves the heat resistance of chocolate, it is also a factor to impair the melt-in-the-mouth texture.

In addition, as a method for improving the heat resistance of chocolate without changing composition of the oils and/or fats, a method has been proposed in which a sugar skeleton is formed in chocolate by mixing a small amount of moisture in a dough. However, there have been problems that viscosity of chocolate dough rapidly increases to deteriorate workability, and the texture of the obtained chocolate loses smoothness.

As oils and/or fats to be used in non-tempering chocolate that can omit a complicated and skilled tempering operation, non-trans fatty acid type and non-lauric acid type oils and/or fats containing 1,2-disaturated and 3-unsaturated triglycerides (SSU; S: saturated fatty acid having 16 to 18 carbons, U: unsaturated fatty acid having 18 carbons) as main components have been developed and put on the market in addition to conventional trans acid type and lauric acid type oils and/or fats.

By using the non-trans fatty acid type and non-lauric acid type oils and/or fats instead of the cocoa butter, a so-called non-tempering type chocolate that does not require the tempering operation can be obtained. (PATENT LITERATURE 3) However, in general, since such non-trans fatty acid type, non-lauric acid type, and non-tempering type oils and/or fats have a melting point higher than that of the cocoa butter, it has been necessary to improve the melt-in-the-mouth texture.

### CITATION LIST

### Patent Literature

PATENT LITERATURE 1: JP-A-2012-04005

PATENT LITERATURE 2: JP-A-2008-154555

PATENT LITERATURE 3: JP-A-2010-148385

### SUMMARY OF INVENTION

### Problems to be Solved by Invention

Therefore, an object of the present invention is to improve the melt-in-the-mouth texture of the oily food without changing triglyceride composition of the oils and/or fats contained in the oily food.

### Solution to Problems

As a result of intensive studies on the above problems, the present inventor has found that the above problems can be solved by incorporating a material that generates heat by contact with moisture into the oily food, in a state not in contact with moisture, and have completed the present invention.

That is, the present invention provides:
(1) an oily food containing a heat-generating material that generates heat by contact with moisture, in a state not in contact with moisture;
(2) the oily food according to (1), in which a calorific value derived from the heat-generating material is 1.0 J/g or more per oily food;
(3) the oily food according to (1), in which moisture present in the oily food without contact with the heat-generating material is 5 wt % or less;
(4) the oily food according to (2), in which moisture present in the oily food without contact with the heat-generating material is 5 wt % or less;
(5) the oily food according to (1), containing 0.1 to 5.0 wt % of the heat-generating material;
(6) the oily food according to (2), containing 0.1 to 5.0 wt % of the heat-generating material;
(7) the oily food according to (3), containing 0.1 to 5.0 wt % of the heat-generating material;
(8) the oily food according to (4), containing 0.1 to 5.0 wt % of the heat-generating material;
(9) the oily food according to any one of (1) to (8), in which the heat-generating material is zeolite;
(10) the oily food according to any one of (1) to (8), in which the heat-generating material is a calcium compound;
(11) the oily food according to any one of (1) to (8), in which the heat-generating material is a mixture of a calcium compound and an organic acid;
(12) the oily food according to any one of (1) to (8), in which a calorific value of the heat-generating material is 50 J/g or more per heat-generating material;
(13) the oily food according to (9), in which a calorific value of the heat-generating material is 50 J/g or more per heat-generating material;
(14) the oily food according to (10), in which a calorific value of the heat-generating material is 50 J/g or more per heat-generating material;
(15) the oily food according to (11), in which a calorific value of the heat-generating material is 50 J/g or more per heat-generating material;
(16) a method for producing an oily food, the method including incorporating a heat-generating material that generates heat by contact with moisture into the oily food, in a state not in contact with moisture;
(17) the method for producing the oily food according to (16), the method including adjusting a calorific value derived from the heat-generating material to 1.0 J/g or more per oily food;
(18) a method for improving melt-in-the-mouth texture of an oily food by incorporating a heat-generating material that generates heat by contact with moisture into the oily food, in a state not in contact with moisture; and
(19) a melt-in-the-mouth texture improver for oily food, containing as an active ingredient a heat-generating material that generates heat by contact with moisture.

### Effects of Invention

According to the present invention, since it is not necessary to change the triglyceride composition of oils and/or fats composition to be blended in order to improve the melt-in-the-mouth texture of the oily food, production cost thereof can be suppressed. In addition, since it is not necessary to sharpen the melting properties of the oils and/or fats composition, it is possible to reduce the risk such as the occurrence of blooming in the oily food due to this.

### DESCRIPTION OF EMBODIMENT

Hereinafter, the present invention will be specifically described.

### Oily Food

The oily food of the present invention is a food having a continuous phase formed of oils and/or fats, such as chocolates, chocolate-like food, filling cream, and sand cream. Generally, the oily food is prepared by mixing solid materials such as saccharides, cocoa solids, milk solids, and pigments together with cocoa butter, vegetable oils, milk fats, and oil-soluble emulsifiers, and is in a state where the solid materials are dispersed in the continuous phase of oils and/or fats. Further, when the oily food of the present invention is a chocolate, it is preferably a chocolate that is eaten at normal temperature.

The oily food of the present invention preferably contains oils and/or fats in an amount of 1 to 60 wt %, more preferably 3 to 50 wt %, and still more preferably 5 to 45 wt %. It is most preferably 10 to 40 wt %.

The oily food of the present invention needs to contain a heat-generating material that generates heat by contact with moisture, in a state not in contact with moisture. Then, a calorific value derived from the heat-generating material is preferably 1.0 J/g or more per oily food. Further, it is more preferably 1.5 J/g or more, still more preferably 2.0 J/g or more, and most preferably 3.0 J/g or more. Furthermore, it is preferably 20.0 J/g or less, and more preferably 15.0 J/g or less.

In the oily food of the present invention, since the heat-generating material comes into contact with moisture to exert an effect of improving melt-in-the-mouth texture, it is preferable that the heat-generating material before being blended in the oily food does not substantially contain free water. Here, the phrase “does not contain free water” specifically means that the water content by a normal pressure weight loss method (105° C. for 5 hours) is preferably 0.3 wt % or less, and more preferably 0.1 wt % or less. Further, the heat-generating material blended in the oily food needs to be present in a state not in contact with moisture. Furthermore, in the oily food of the present invention, the moisture present in the oily food without contact with the heat-generating material is acceptable, but is preferably 5 wt % or less, more preferably 3 wt % or less, and still more preferably 1 wt % or less.

### Material that Generates Heat by Coming into Contact with Moisture

The oily food of the present invention contains the heat-generating material that generates heat by contact with moisture, and the content of the heat-generating material in the oily food is preferably 0.1 wt % or more, more preferably 0.2 wt % or more, still more preferably 0.5 wt % or more, and most preferably 1.0 wt % or more. When the content is less than a lower limit, a sufficient effect of improving the melt-in-the-mouth texture may not be obtained.

Further, the content is preferably 5.0 wt % or less, more preferably 4.5 wt % or less, still more preferably 4.0 wt % or less, and most preferably 3.5 wt % or less. When the content exceeds an upper limit, a taste may be deteriorated depending on the heat-generating material.

The heat-generating material in the present invention needs to generate heat when brought into contact with moisture, and the calorific value is preferably 50 J/g or more, more preferably 100 J/g or more, and still more preferably 150 J/g or more. When the calorific value at the time of contact with moisture is less than the lower limit, it is necessary to blend a large amount of heat-generating material in food in order to obtain the sufficient effect of improving the melt-in-the-mouth texture, and although the effect of improving the melt-in-the-mouth texture can be obtained, the taste may be deteriorated and may not be suitable. Further, the upper limit of the calorific value is preferably 1000 J/g or less, and more preferably 500 J/g or less.

The heat-generating material in the present invention needs to be allowed to be blended in food. Further, the heat-generating material in the present invention is not particularly limited as long as it has a property of generating heat by contact with moisture, and examples thereof include zeolite, amorphous silica (silicon dioxide), and a calcium compound. The heat-generating material in the present invention may be used alone or in combination of a plurality of materials.

Specific examples of the zeolite include A type zeolite and ZSM5 type zeolite. Specific examples of the amorphous silica include SYLOPAGE series manufactured by Fuji Silysia Chemical Ltd. Further, specific examples of the calcium compound include calcium chloride and calcium oxide.

As the heat-generating material in the present invention, a combination mixture of calcium oxide and an organic acid is specifically exemplified. Here, specific examples of the organic acid include citric acid, ascorbic acid, erythorbic acid, gallic acid, and malic acid. Since heat generation of these mixtures is considered to be due to heat generation by a neutralization reaction in addition to hydration heat and dissolution heat due to contact with water, the combination of calcium oxide and the organic acid preferably has a mixing ratio corresponding to around an equivalence point of the neutralization reaction. For example, when the organic acid is citric acid, a weight ratio of calcium oxide/citric acid is preferably 1.0 to 4.0 and more preferably 1.5 to 3.0.

A heat generation mechanism due to contact with moisture is not particularly limited, and examples thereof include hydration heat, dissolution heat, neutralization heat, generation heat, combustion heat, and combinations thereof.

The heat-generating material in the present invention may be in a powder form, a granular form, or the like, but in particular, when an average particle diameter is 20 microns or less, texture of the oily food is smooth, and at the same time, heat generation due to contact with moisture occurs early, and thus improvement of the melt-in-the-mouth texture of the oily food easily appears, which is preferable.

### Edible Oils and/or Fats

Edible oils and/or fats used in an oil and/or fat composition of the present invention is not particularly limited, but edible oils and/or fats having physical properties suitable for the oily food are desirable. Specifically, one or more of vegetable oils such as cocoa butter, coconut oil, palm kernel oil, MCT, palm oil, sunflower oil, rapeseed oil, soybean oil, rice bran oil, corn oil, cottonseed oil, shea butter, sal fat, kokum butter, and illipe butter, animal fats such as lard, beef tallow, and fish oil, hydrogenated oils, fractionated oils, and interesterified oils of such animal and vegetable oils and/or fats can be appropriately selected and used.

### Mechanism of Action and Effect

Regarding a mechanism in which the effect of improving the melt-in-the-mouth texture appears in the oily food of the present invention, it is considered that a material that is dispersed in the oily food and generates heat by contact with moisture at the time of eating obtains moisture such as saliva in the mouth and causes an exothermic reaction, and thus the material compensates heat absorption originally required when the oils and/or fats are dissolved, and the effect can be obtained by increasing dissolution rate of the oils and/or fats.

### EXAMPLES

Examples will be described below, but the technical idea of the present invention is not limited by these examples. Note that in Examples, parts and % are both based on weight.

### <Study 1> Study on Heat-Generating Material

Calorific values of various materials were evaluated. The evaluation method was in accordance with “—Method for evaluating calorific value of material that generates heat by contact with moisture”. Results are described below.
A-type zeolite Zeoal 4A (manufactured by Nakamura Choukou Co., Ltd.), average particle diameter: 0.051 μm: 229.8 J/g
ZSM-5 type zeolite Zeoal ZSM-5 (manufactured by Nakamura Choukou Co., Ltd.), average particle diameter: 0.103 μm: 25.5 J/g
*Calcium chloride (manufactured by FUJIFILM Wako Pure Chemical Corporation): 234.2 J/g
*Calcium oxide (manufactured by FUJIFILM Wako Pure Chemical Corporation): 25.7 J/g
*Citric acid (manufactured by FUJIFILM Wako Pure Chemical Corporation): −90.5 J/g
*Mixture of 2 parts by weight of calcium oxide and 1 part by weight of citric acid: 258.0 J/g
*Sugar: −12.9 J/g
(*Grinding was performed with a mortar, and the average particle diameter was adjusted to 8 μm or less.)

A-type zeolite Zeoal 4A, ZSM-5 type zeolite Zeoal ZSM-5, calcium chloride, calcium oxide, and the mixture of 2 parts by weight of calcium oxide and 1 part by weight of citric acid were all heat-generating materials that generated heat by contact with water. On the other hand, citric acid and sugar were endothermic materials.

### Method for Evaluating Calorific Value of Material that Generates Heat by Contact with Moisture

In an atmosphere at 25° C., 50 parts by weight of water and 5 parts by weight of a raw material were mixed and stirred, and the calorific value (J/g) of the raw material was calculated from an increase in water temperature after 2 minutes.

### <Study 2>Effect of Addition to Tempering Type Chocolate

Tempering type chocolates were experimentally produced according to a conventional method with formulation in Table 1. The product temperature of a chocolate dough formed into a paste by mixing and rolling, and conching was adjusted to 30° C., a seed agent (manufactured by Fuji Oil Co., Ltd./product name “Choco Seed A”) was added in an amount of 0.2 parts by weight to the chocolate, and the chocolate was tempered, cooled and solidified, and then aged for 1 week to obtain a chocolate (oil content: about 34 wt %). The melt-in-the-mouth texture of the obtained chocolate was evaluated according to “—Method for evaluating effect of improving melt-in-the-mouth texture”, and an improving effect by the heat-generating material was checked. Table 1 shows the results. Note that the water contents of Examples and Comparative Example were all 0.8 wt %. As a measurement method, a normal pressure heating weight loss method (105°° C. for 5 hours) was used.

### Method for Evaluating Effect of Improving Melt-in-the-Mouth Texture

Five well-trained panelists engaged in development work compared the melt-in-the-mouth texture for prepared chocolate or sandwich filling.

In the evaluation of the melt-in-the-mouth texture, compared with Comparative Example 1 in Studies 2 and 3, compared with Comparative Example 4 in Study 4, and compared with Comparative Example 5 in Study 5,
A: the melt-in-the-mouth texture improved greatly,
B: the melt-in-the-mouth texture improved,
C: the melt-in-the-mouth texture slightly improved,
—: no effect of improving melt-in-the-mouth texture was found (equivalent to Comparative Example),
D: melt-in-the-mouth texture was deteriorated, and
E: melt-in-the-mouth texture was greatly deteriorated.

### Method for Evaluating Heat Resistance of Chocolate

The produced chocolate was held at 30° C., 31° C., 32° C., and 33° C., and a maximum load was measured with a creep meter (RHEONER II manufactured by Yamaden Co., Ltd., plunger φ3 mm, pushing speed 5 mm/sec). A temperature at which the maximum load was 200 gf was defined as a heat resistant temperature.

TABLE 1

| | Calorific value | | | | | | | | | |
|---|---|---|---|---|---|---|---|---|---|---|
| | of heat- | | | | | | | | | |
| | generating | Reference | Comparative | Example | Example | Example | Example | Example | Example | Example |
| | material (J/g) | example | Example 1 | 1 | 2 | 3 | 4 | 5 | 6 | 7 |
| Sugar | — | 47.2 | 47.2 | 46.7 | 46.2 | 45.2 | 44.2 | 46.7 | 46.2 | 46.2 |
| Cocoa mass | — | 41.3 | 41.3 | 41.3 | 41.3 | 41.3 | 41.3 | 41.3 | 41.3 | 41.3 |
| Cocoa butter | — | 11.0 | 3.0 | 3.0 | 3.0 | 3.0 | 3.0 | 3.0 | 3.0 | 3.0 |
| Melano NEW.88-7 | | | 8.0 | 8.0 | 8.0 | 8.0 | 8.0 | 8.0 | 8.0 | 8.0 |
| Zeoal 4A | 229.8 | | | 0.5 | 1.0 | 2.0 | 3.0 | | | |
| ZSM5 | 25.5 | | | | | | | | | |
| Calcium chloride | 234.2 | | | | | | | 0.5 | 1.0 | |
| Calcium oxide | 25.7 | | | | | | | | | |
| Citric acid | −90.5 | | | | | | | | | |
| Mixture of | 258.0 | | | | | | | | | 1.0 |
| calcium oxide | | | | | | | | | | |
| and citric | | | | | | | | | | |
| acid | | | | | | | | | | |
| Lecithin | | 0.5 | 0.5 | 0.5 | 0.5 | 0.5 | 0.5 | 0.5 | 0.5 | 0.5 |
| Total | | 100.0 | 100.0 | 100.0 | 100.0 | 100.0 | 100.0 | 100.0 | 100.0 | 100.0 |
| Fat (%) | | 34.0 | 34.0 | 34.0 | 34.0 | 34.0 | 34.0 | 34.0 | 34.0 | 34.0 |
| Calorific value | | 0.0 | 0.0 | 1.1 | 2.3 | 4.6 | 6.9 | 1.2 | 2.3 | 2.6 |
| derived from | | | | | | | | | | |
| heat-generating | | | | | | | | | | |
| material in | | | | | | | | | | |
| food (J/g) | | | | | | | | | | |
| Effect of improving | | — | | B | A | A | A | B | A | A |
| melt-in-the-mouth | | | | | | | | | | |
| texture | | | | | | | | | | |

Melano NEW.SS-7 (manufactured by Fuji Oil Co., Ltd.) was used as a tempering type cocoa butter equivalent (CBE).

### Consideration of Table 1

In Examples 1 to 7 containing the heat-generating material, the effect of improving the melt-in-the-mouth texture was remarkable according to the calorific value derived from the heat-generating material, and the effect of improving the melt-in-the-mouth texture was clearly confirmed by blending the heat-generating material.

### <Study 3>Effect of Addition to Heat Resistant Tempering Type Chocolate

Tempering type chocolates were experimentally produced in the same manner as in Study 2 with formulation in Table 2. The melt-in-the-mouth texture and heat resistance of the obtained chocolate were evaluated, and the improving effect by the heat-generating material was checked. The evaluation was performed in accordance with “—Method for evaluating effect of improving melt-in-the-mouth texture” and “—Method for evaluating heat resistance of chocolate”. Table 2 shows the results. Note that the water contents of Examples and Comparative Examples were all 0.8 wt %. As a measurement method, a normal pressure heating weight loss method (105° C. for 5 hours) was used.

TABLE 2

| | Calorific value | | | | | |
|---|---|---|---|---|---|---|
| | of heat- | | | | | |
| | generating | Comparative | Comparative | Example | Example | Example |
| | material (J/g) | Example 1 | Example 2 | 8 | 9 | 10 |
| Sugar | — | 47.2 | 47.2 | 46.2 | 45.2 | 46.2 |
| Cocoa mass | — | 41.3 | 41.3 | 41.3 | 41.3 | 41.3 |
| Cocoa butter | — | 3.0 | 3.0 | 3.0 | 3.0 | 3.0 |
| Melano NEW.88-7 | | 8.0 | 6.0 | 6.0 | 6.0 | 6.0 |
| Melano 88-400 | | | 2.0 | 2.0 | 2.0 | 2.0 |
| Zeoal 4A | 229.8 | | | 1.0 | 2.0 | |
| ZSM5 | 25.5 | | | | | |
| Calcium chloride | 234.2 | | | | | 1.0 |
| Lecithin | | 0.5 | 0.5 | 0.5 | 0.5 | 0.5 |
| Total | | 100.0 | 100.0 | 100.0 | 100.0 | 100.0 |
| Fat (%) | | 34.0 | 34.0 | 34.0 | 34.0 | 34.0 |
| Calorific value | J/g | 0.0 | 0.0 | 2.3 | 4.6 | 2.3 |
| derived from | | | | | | |
| heat-generating | | | | | | |
| material in | | | | | | |
| food (J/g) | | | | | | |
| Effect of improving | | | D | C | B | C |
| melt-in-the-mouth | | | | | | |
| texture | | | | | | |
| Heat resistant | ° C. | 30.9 | 32.6 | 32.0 | 32.0 | 33.0 |
| temperature | | | | | | |
| Comprehensive | | failed | failed | passed | passed | passed |
| evaluation | | | | | | |

| | Example | Comparative | Example | Example | Example | Example |
|---|---|---|---|---|---|---|
| | 11 | Example 3 | 12 | 13 | 14 | 15 |
| Sugar | 45.2 | 47.2 | 46.2 | 45.2 | 46.2 | 45.2 |
| Cocoa mass | 41.3 | 41.3 | 41.3 | 41.3 | 41.5 | 41.3 |
| Cocoa butter | 3.0 | 3.0 | 3.0 | 3.0 | 3.0 | 3.0 |
| Melano NEW.88-7 | 6.0 | 4.0 | 4.0 | 4.0 | 4.0 | 4.0 |
| Melano 88-400 | 2.0 | 4.0 | 4.0 | 4.0 | 4.0 | 4.0 |
| Zeoal 4A | | | 1.0 | 2.0 | | |
| ZSM5 | | | | | | |
| Calcium chloride | 2.0 | | | | 1.0 | 2.0 |
| Lecithin | 0.5 | 0.5 | 0.5 | 0.5 | 0.5 | 0.5 |
| Total | 100.0 | 100.0 | 100.0 | 100.0 | 100.0 | 100.0 |
| Fat (%) | 34.0 | 34.0 | 34.0 | 34.0 | 34.0 | 34.0 |
| Calorific value | 4.7 | 0.0 | 2.3 | 4.6 | 2.3 | 4.7 |
| derived from | | | | | | |
| heat-generating | | | | | | |
| material in | | | | | | |
| food (J/g) | | | | | | |
| Effect of improving | B | E | — | C | — | C |
| melt-in-the-mouth | | | | | | |
| texture | | | | | | |
| Heat resistant | 32.0 | 32.5 | 32.9 | 32.9 | 32.9 | 32.9 |
| temperature | | | | | | |
| Comprehensive | passed | failed | passed | passed | passed | passed |
| evaluation | | | | | | |

Melano NEW.SS-7 (manufactured by Fuji Oil Co., Ltd.) was used as a tempering type cocoa butter equivalent (CBE).

Melano SS400 (manufactured by Fuji Oil Co., Ltd.) was used as a heat resistance-imparting type tempering type cocoa butter equivalent (CBE).

### Comprehensive Evaluation

It was evaluated that the heat resistance was able to be improved and deterioration of the melt-in-the-mouth texture was able to be suppressed.

When the melt-in-the-mouth texture was equal to or better than that in Comparative Example 1 and the heat resistant temperature is increased by 1° C. or more, the chocolate was evaluated as acceptable (passed) in comprehensive evaluation. Unacceptable one was evaluated as failed.

### Consideration of Table 2

In each of Examples 8 to 11 containing the heat-generating material, the heat resistance was improved by about 1° C. as compared with Comparative Example 1, and moreover, the melt-in-the-mouth texture was improved according to the calorific value derived from the heat-generating material. Further, in Examples 12 to 15 containing the heat-generating material, the heat resistance was improved by about 2° C. as compared with Comparative Example 1, and moreover, the melt-in-the-mouth texture was improved or not deteriorated according to the calorific value derived from the heat-generating material.

That is, it was clearly confirmed that even when the heat resistance was improved by blending a heat resistant CBE, the melt-in-the-mouth texture was improved or suppressed to be deteriorated by an effect of blending the heat-generating material.

### <Study 4>Effect of Addition to Non-Tempering Type Chocolate

Non-tempering type chocolates were experimentally produced according to a conventional method with formulation in Table 3. The product temperature of a chocolate dough formed into a paste by mixing and rolling, and conching was adjusted to 60° C. The chocolate dough was cooled and solidified, and then aged for 1 week to obtain a chocolate (oil content: about 39 wt %). The melt-in-the-mouth texture of the obtained chocolate was evaluated, and the improving effect by the heat-generating material was checked. The evaluation was performed in accordance with “—Method for evaluating effect of improving melt-in-the-mouth texture”. Table 3 shows the results. Note that the water contents of Examples and Comparative Example were all 1.1 wt %. As a measurement method, a normal pressure heating weight loss method (105° C. for 5 hours) was used.

TABLE 3

| | Calorific value | | | | | | | |
|---|---|---|---|---|---|---|---|---|
| | of heat- | | | | | | | |
| | generating | Comparative | Example | Example | Example | Example | Example | Example |
| | material (J/g) | Example 4 | 16 | 17 | 18 | 19 | 20 | 21 |
| Sugar | — | 44.0 | 43.5 | 43.0 | 42.0 | 43.5 | 43.0 | 43.0 |
| Non-tempering type | | 29.5 | 29.5 | 29.5 | 29.5 | 29.5 | 29.5 | 29.5 |
| oils and/or fats | | | | | | | | |
| Cocoa powder | — | 10.0 | 10.0 | 10.0 | 10.0 | 10.0 | 10.0 | 10.0 |
| Whole milk powder | — | 9.0 | 9.0 | 9.0 | 9.0 | 9.0 | 9.0 | 9.0 |
| Cocoa butter | — | 5.0 | 5.0 | 5.0 | 5.0 | 5.0 | 5.0 | 5.0 |
| Cocoa mass | — | 2.0 | 2.0 | 2.0 | 2.0 | 2.0 | 2.0 | 2.0 |
| Zeoal 4A | 229.8 | | 0.5 | 1.0 | 2.0 | | | |
| ZSM5 | 25.5 | | | | | | | |
| Calcium chloride | 234.2 | | | | | 0.5 | 1.0 | |
| Mixture of calcium | 258.0 | | | | | | | 1.0 |
| oxide and citric acid | | | | | | | | |
| Lecithin | | 0.5 | 0.5 | 0.5 | 0.5 | 0.5 | 0.5 | 0.5 |
| Total | | 100.0 | 100.0 | 100.0 | 100.0 | 100.0 | 100.0 | 100.0 |
| Fat (%) | | 38.6 | 38.6 | 38.6 | 38.6 | 38.6 | 38.6 | 38.6 |
| Calorific value | | 0.0 | 1.1 | 2.3 | 4.6 | 1.2 | 2.3 | 2.6 |
| derived from | | | | | | | | |
| heat-generating | | | | | | | | |
| material in | | | | | | | | |
| food (J/g) | | | | | | | | |
| Effect of improving | | | B | A | A | B | A | A |
| melt-in-the-mouth | | | | | | | | |
| texture | | | | | | | | |

Melano NT-R (manufactured by Fuji Oil Co., Ltd.) was used as a interesterification type non-tempering type cocoa butter replacer (CBR).

### Consideration of Table 3

In Examples 16 to 21 containing the heat-generating material, the effect of improving the melt-in-the-mouth texture was remarkable according to the calorific value, and the effect of improving the melt-in-the-mouth texture by blending the heat-generating material was clearly confirmed.

### <Study 5>Effect of Addition to Sandwich Filling

A specific gravity was reduced to 0.85 g/ml by a whipper according to a conventional method with formulation in Table 4, and sandwich filling was experimentally produced through aging for 1 week. The melt-in-the-mouth texture of the obtained sandwich filling was evaluated, and the improving effect by the heat-generating material was checked. The evaluation was performed in accordance with “-Method for evaluating effect of improving melt-in-the-mouth texture”. Table 4 shows the results. Note that the water contents of Examples and Comparative Example were all 1.4 wt %. As a measurement method, a normal pressure heating weight loss method (105° C. for 5 hours) was used.

TABLE 4

| | Calorific value | | | | | | | |
|---|---|---|---|---|---|---|---|---|
| | of heat- | | | | | | | |
| | generating | Comparative | Example | Example | Example | Example | Example | Example |
| | material (J/g) | Example 5 | 22 | 23 | 24 | 25 | 26 | 27 |
| Sugar | — | 40.0 | 39.5 | 39.0 | 38.0 | 39.5 | 39.0 | 39.0 |
| SHBBLT20 | | 40.0 | 40.0 | 40.0 | 40.0 | 40.0 | 40.0 | 40.0 |
| Whole milk powder | — | 20.0 | 20.0 | 20.0 | 20.0 | 20.0 | 20.0 | 20.0 |
| Zeoal 4A | 229.8 | | 0.5 | 1.0 | 2.0 | | | |
| ZSM5 | 25.5 | | | | | | | |
| Calcium chloride | 234.2 | | | | | 0.5 | 1.0 | |
| Mixture of | 258.0 | | | | | | | 1.0 |
| calcium oxide | | | | | | | | |
| and citric acid | | | | | | | | |
| Total | | 100.0 | 100.0 | 100.0 | 100.0 | 100.0 | 100.0 | 100.0 |
| Fat (%) | | 44.8 | 44.8 | 44.8 | 44.8 | 44.8 | 44.8 | 44.8 |
| Calorific value | | 0.0 | 1.1 | 2.3 | 4.6 | 1.2 | 2.3 | 2.6 |
| derived from | | | | | | | | |
| heat-generating | | | | | | | | |
| material in | | | | | | | | |
| food (J/g) | | | | | | | | |
| Effect of improving | | | B | A | A | B | A | A |
| melt-in-the-mouth | | | | | | | | |
| texture | | | | | | | | |

As shortening, Pampas Palmy BBLT20 (manufactured by Fuji Oil Co., Ltd.) was used.

### Consideration of Table 4

In Examples 22 to 27 containing the heat-generating material, the effect of improving the melt-in-the-mouth texture was remarkable according to the calorific value, and the effect of improving the melt-in-the-mouth texture by blending the heat-generating material was clearly confirmed.

### INDUSTRIAL APPLICABILITY

According to the present invention, it is possible to provide a food that has achieved improvement in the melt-in-the-mouth texture required for a processed food containing oils and/or fats, and a method for producing the same.

1. An oily food comprising a heat-generating material that generates heat by contact with moisture, in a state not in contact with moisture, wherein the heat-generating material is zeolite.

2. The oily food according to claim 1, wherein a calorific value derived from the heat-generating material is 1.0 J/g or more per oily food.

3. The oily food according to claim 1, wherein an amount of moisture present in the oily food without contact with the heat-generating material is 5 wt % or less.

4. (canceled)

5. The oily food according to claim 1, comprising 0.1 to 5.0 wt % of the heat-generating material.

6. The oily food according to claim 2, comprising 0.1 to 5.0 wt % of the heat-generating material.

7. The oily food according to claim 3, comprising 0.1 to 5.0 wt % of the heat-generating material.

8-19. (canceled)

20. The oily food according to claim 2, wherein an amount of moisture present in the oily food without contact with the heat-generating material is 5 wt % or less.

21. The oily food according to claim 20, comprising 0.1 to 5.0 wt % of the heat-generating material.
